(19) United States
(12) Patent Application Publication
(10) Pub. No.: US 2007/0038863 A1
(43) Pub. Date: Feb. 15, 2007

(54) System and Method for Decoupling Identification from Biometric Information in Biometric Access Systems

(76) Inventors: Nhan Nguyen, Lafayette, CA (US); Larry Hollowood, Danville, CA (US); Arun Mammen Thomas, San Francisco, CA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/456,409

(22) Filed: Jul. 10, 2006

Related U.S. Application Data
(62) Division of application No. 10/689,381, filed on Oct. 20, 2003, now Pat. No. 7,129,239.
(60) Provisional application No. 60/697,891, filed on Jul. 8, 2005.

(51) Int. Cl. G06F 21/06

(52) U.S. Cl. 713/176

(57) ABSTRACT

A system and method are provided for providing increased security when storing biometric information and personal information in a biometric access system. A personal information number or personal search code that is known only to the individual and not stored by the biometric access system may be used to generate encryption keys, bin numbers and addresses in the biometric access system that make it difficult to access biometric information or relate biometric information to personal information that may be stored in a segregated database.

### CLAIM OF PRIORITY

This application claims priority under 35 U.S.C. §119(c) from provisional application 60/697,891 filed Jul. 8, 2005. The No. 60/697,891 provisional application is incorporated by reference herein, in its entirety, for all purposes.

### BACKGROUND

1. Technical Field

The disclosed embodiments pertain to secure methods for storing biometric templates and more specifically, a system and method for minimizing the risk of coupling an identification record to decrypted biometric information in a database.

2. Background

Current real-time biometric access systems typically store an individual's biometric information, such as a fingerprint image or biometric template, in a secure database and in encrypted form. When an individual desires access to a system protected by a biometric access system, the individual presents biometric information (e.g., his fingerprint) via a biometric scanner (e.g., fingerprint scanner) and, regardless of whether the biometric access system is used for verification or identification purposes, such biometric information (hereinafter referred to as the “sample” biometric or biometric information) is ultimately compared to the biometric information previously obtained from the individual during an registration or enrollment process and now stored in the database (hereinafter referred to as the “registered” biometric or biometric information). Those of ordinary skill in the art will recognize that a biometric image, such as a fingerprint image, can be converted into a biometric “template” prior to either storage and/or comparison. Such biometric templates are digital transformations typically based on proprietary algorithms that convert a biometric image, such as a digital fingerprint image, into a digital representation of observed points in the fingerprint image and relationships between those points. Such transformation thereby enables the comparison of one biometric template against another in order to assess the closeness of a match and determine whether there has been an authentication. Typically, the threshold of confidence, or level of closeness of the match, can be adjusted depending upon the need for higher or lower confidence in the comparison. A higher threshold may lead to a higher “false rejection rate” while a lower threshold may lend to a higher “false acceptance rate.”

Authentication of an individual generally requires the submission by the individual of sample biometric information as well as a personal identification number (“PIN”) via. for example, a PIN pad, keypad, keyboard or other input device or mechanism (e.g., a card scanner, etc.). The PIN is often a common, fixed-sized number, such as the individual's telephone number, or other alphanumeric sequence, and it need not be unique to the particular individual. In a verification system, the PIN may be used to locate a single registered biometric information in the database against which the sample biometric information will be compared to authenticate an individual. Alternatively, in an identification system, the PIN may be used to identify a subset of registered biometric information (e.g., hereinafter referred to as “bin” or a “basket”) in the database against which the sample biometric information will be compared against to find a potential match which shall reveal an identify that is linked to the particular registered biometric information which is matched.

FIG. 1 depicts an exemplary biometric access system for authentication purposes utilizing binning or basketing technology. Binning is often used to enhance the search speed by limiting the number of registered biometric information (e.g., biometric templates) in each bin, such as 115. In a binning embodiment of a biometric access system, the PIN may also be referred to as a personal search code (“PSC”) 105 and need not be unique to each individual. The PSC 105 is used to identify a bin number 110 for the bin 115 that includes one or more biometric templates encrypted with an encryption key 120. The encryption key 120 is known by the biometric access system and is used as an additional security mechanism to reduce the risk of storing biometric information in a database. The biometric access system performs a 1:N matching of sample biometric information against the registered biometric information stored in the bin 115. Because only a subset of the registered biometric information is located in bin 115, search times are improved.

Consumer advocacy and privacy groups have expressed concerns that an individual's biometric information stored in such biometric access systems can be accessed by third parties for differene uses that originally intended and without the explicit authorization of the individual. For example, local authorities could subpoena the biometric information to assist in a criminal investigation or for other purposes. Such a subpoena my force the biometric access system provider to divulge access to its entire database, including all internally managed encryption keys, encryption and biometric conversion algorithms, system methods and processes. With the entire knowledge base of the biometric access system provider, the local authorities would be able to easily obtain decrypted biometric images and their relationship to individual identities. Consumer advocacy and privacy groups maintain that the risk of storage of biometric information in a database that can be accessed by authorities or others who may use the database in ways not intended may outweigh its benefit.

Accordingly, what is needed is a system and method for securely storing biometric information such that the information can only be accessed with the explicit participation of the individual such that the biometric access system provider cannot itself decrypt or otherwise obtain an individual's biometric information without the individual's participation or assistance.

### SUMMARY

The present disclosure related to methods for using information known only to an individual desiring access to a biometric access system in order to access stored biometric information in the biometric access system. Such methods minimize the risk of storing information in the biometric access system such that in the event such a biometric access system is compromised, the information stored in that system is insufficient to decrypt stored biometric information or link such biometric information to personal data stored in the system.

In the particular, a method comprises receiving a PIN from an individual, obtaining biometric information associated with the individual, applying a calculation on the PIN, wherein the result of the calculation serves as an encryption key, encrypting the biometric information using the result of the calculation as an encryption key; and storing the encrypted biometric information in the database. The method may be further enhanced, for example, in an identification system by further applying a second calculation on the PIN, wherein the result of the second calculation serves as a bin number in the database in which to store the biometric information, and wherein storing the encrypted biometric information in the database comprises storing the encrypted biometric information in a bin associated with the bin number. Additionally, the present disclosure discloses a method for minimizing the risk of storing personal information and biometric information by using the PIN to calculate the actual address of an individual's record where the personal information is stored. In this manner, even if the biometric information is decrypted, for example, by a brute force method, the link between the biometric information and the individual's record still cannot be determined without the PIN from the individual (and therefore and identify cannot be determined based purely on the biometric information).

### BRIEF DESCRIPTION OF THE DRAWINGS

Aspects, features, benefits and advantages of the present invention will be apparent with regard to the following description and accompanying drawings, of which:

FIG. 1 depicts a biometric access system for authentication purposes utilizing binning or basketing technology.

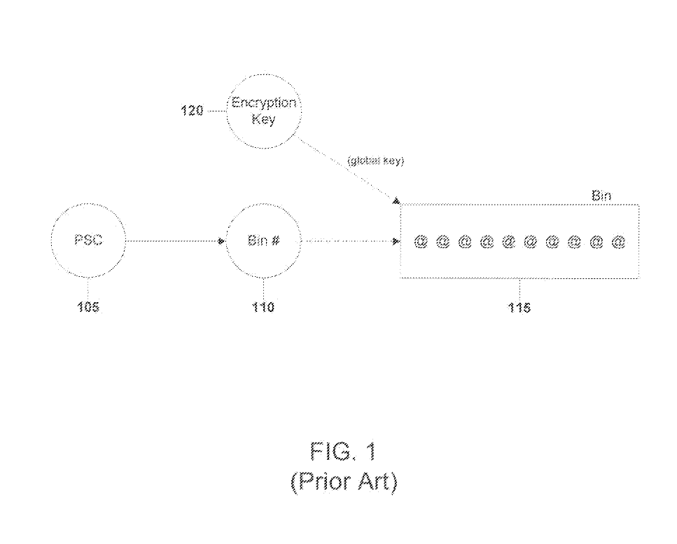

FIG. 2 depicts an exemplary process flow for a biometric access system according to the present invention.

FIG. 3 depicts a system diagram for an exemplary biometric access system separating biometric information and personal information and access thereto.

FIG. 4 depicts a relationship between a biometric access database and a consumer information database in accordance with one embodiment.

FIG. 5 depicts a block diagram for enrollment and authentication of biometric data in a biometric access system according to the present invention.

FIG. 6 depicts a flow diagram for an exemplary enrollment process in a biometric access system according to the present invention.

FIG. 7 depicts a flow diagram for an exemplary authentication process in a biometric access system according to the present invention.

### DETAILED DESCRIPTION

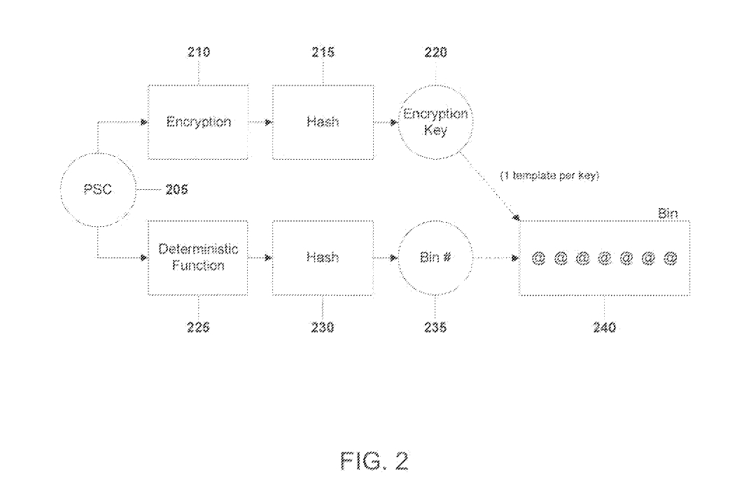

FIG. 2 depicts an exemplary access flow for an embodiment of a biometric access system for identification purposes that utilizes binning for increased searching efficiency. As shown in FIG. 2, an individual's PSC 205 that is entered at the point-of-access, such as a PIN pad at a point-of-sale (“POS”) terminal at a merchant location, may be used for the calculation of both an encryption key 220 and a bin number 235 that is used to locate the individual's registered biometric information, in this case, a stored biometric template, in the database of the biometric access system. The encryption key 220 may be dynamically calculated in real-time during the individual's access process using, for example, a combination of a strong symmetric encryption algorithm 210 and a one-way hash function 215 on the submitted PSC 205. The one-way hash function 215 may prevent reverse engineering of the PSC 205 from the encryption key 220. An exemplary one-way hash function is the SHA256 hashing function. Because the encryption key 220 is generated from the PSC 205, the encryption key need not be stored in the biometric access systems' database, thereby making the encryption key more difficult to determine that in current existing solutions as previously discussed, where the encryption key is always known to the biometric access system. For example and without limitation, the Advanced Encryption Standard (“AES”) using a 256 bit key may be used as the encryption algorithm 210 in one embodiment. While the 256 bit key used with the AES algorithm would be stored and known by the biometric access system, the encryption key 220, as previously discussed, may not be permanently stored in the database, but may be generated in real-time during an individual's access request. However, the encryption key 220 may be temporarily stored during the access request. In an alternative embodiment, a one-to-one deterministic function (i.e., a function that outputs a unique result for each unique input) other than an encryption algorithm that needs to use of a key may be used at 210. During a registration or enrollment process, the individual may select (or be given) a PSC to be used in future system access attempts and the individual's registered biometric information (e.g., biometric template) may be encrypted with the encryption key 220 (obtained by applying the same encryption algorithm 220 and one-way hash function 215 to the PSC as used during the point-of-access process) prior to being stored in a bin 240.

Likewise, the bin number 235 may be dynamically calculated in real-time during the individual's access process based on a combination of a deterministic function 225 performed using the individual's PSC 205 and a one-way hash 230 of the result of the deterministic function calculation. The deterministic function 225 may be used to ensure that a single bin, such as 240, may include registered biometric information associated with a plurality of different individuals who have selected difference PSCs, such as 205. For example and without limitation, one such possible deterministic function that my be used in an embodiment is to extract a certain sequential subset of the PSC (e.g., digits 2 through 7 in a PSC of 10 digits, for example). As a result of the one-way hashing function 230 (which may or may not be the same as the one-way hash function 215 depending upon the embodiment), the bin number 235 that is stored in the database of the biometric access system may significantly reduce the risk that a PSC 205 can be reversed engineered from knowledge of the bin number 235 and subsequently passed though the encryption algorithm 210 and hash function 215 in order to derive the encryption key 220.

As can be seen, once the individual submits his PSC at a point-of-access, the resulting dynamically generated encryption key 220 and the bin number 235 may then be used to access the bin 240 in the biometric access system's database containing the individual's registered biometric information and subsequently to decrypt the biometric information with the encryption key 220. Because different PSCs can lead to the same bin, not all biometric information within a particular bin 240 may be encrypted with the same encryption key 220. That is, given a particular one-way hash function, it is possible that different PSCs (with different encryption keys) can hash to the same bin number. As such, the risk of exposing all biometric information in a particular bin 240 when a particular PSC relating to a particular bin number 235 and a encryption key 220 is compromised may decrease because the encryption keys for different biometric templates in the bin may differ.

Those with ordinary skill in the art will recognize that using different encryption algorithms, deterministic functions and hashing techniques may increase the security of an embodiment. One goal of using a different encryption algorithm in 210 and deterministic function 225 may be to ensure that the bin number 235 and the encryption key 220 are not readily derived from one another because the encryption algorithm would provide a different value that the deterministic function. Similarly, different algorithms for hash functions 215 and 230 may also or alternatively be used to further disassociate the encryption key 220 from the bin number 235. Accordingly, derivation of the encryption key 220 from the bin number 235 becomes difficult and may only be readily obtained in a dynamic fashion from an offered PSC 205. Those with ordinary skill in the art will recognize, consistent with the teachings herein, that in alternative embodiments, additional encryption, hashing, and other security-based computations may be performed in the process flows set forth in FIG. 2, such as prior to computing the deterministic function 225, to make reverse engineering of the PSC 205 even more difficult.

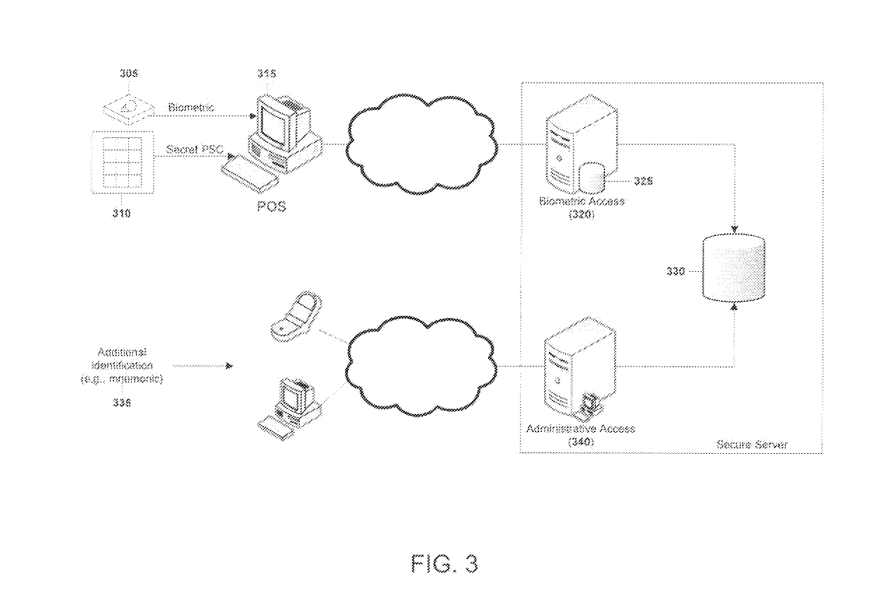

FIG. 3 depicts a system diagram for one embodiment of a biometric access system wherein registered biometric information and personal information are handled differently. In such an embodiment, individuals' registered biometric information and personal information (e.g., payment modalities, demographic information, payment details, etc.) may be segregated and stored in separate databases, for example, to address varying security and access capabilities. An individual's account information may be accessible by the individual via a biometric access path by submitting the individual's biometric sample and PSC (for transactions). Alternatively, administrators of the biometric access system (or the individuals themselves, after proper authentication through additional identification methods, such as a username, passcode or other mnemonic) may be able to utilize and administrative access path to configure, audit, modify or otherwise access an individual's account information (e.g., per the request of the individual) for administrative purposes. As shown in FIG. 3, in the biometric access path, biometric information (e.g., biometric image) and a PSC may be provided by the individual at a POS terminal 315. The POS terminal 315 may obtain the biometric information (e.g., a biometric image) submitted through a biometric scanner 305 and a PSC submitted through a PIN pad 310. In one embodiment, the biometric image may be converted into a biometric template and the template and PSC may then be submitted to the biometric access server 320 for comparison with registered biometric information stored in the database 325. Those with ordinary skill in the art will recognize that other methods and interactions with the biometric access server 320 may be used consistent with the teachings herein. For example and without limitation, in an alternative embodiment, only the PSC may be submitted to the biometric access server 320 which may return the registered biometric template to be compared at the POS terminal 315. Alternatively, the actual biometric image rather that a converted template may be sent to the biometric access server 320 and the conversion to a template may be performed at the biometric access server 320. Ultimately, the registered biometric information (e.g., registered biometric template or biometric image depending upon embodiments) stored in the database 325 may be located by manipulating the received PSC as previously discussed and depicted in FIG. 2. If the sample biometric information is authenticated against a particular registered biometric information in a particular bin in database 325, account information corresponding to the biometric template and containing information pertaining to the individual may be accessed from a consumer information database 330. The consumer information database 330 may include, without limitation, demographic information, payment modalities (e.g., credit card number, debit card number, checking account, etc.), payment details, payment history, membership information, and the like.

In an administrative access path, access to information in the database 330 may be provided for administrative purposes such as auditing, account modifications, troubleshooting and the like. An individual who has registered and enrolled in the biometric access system, for example, may request account related changes through the secure administrative access server 340 by providing alternate and/or additional identification 335, such as a username, passcode, mnemonic or the like. As depicted in FIG. 3, the biometric information is stored in a separate database 325 from the consumer information database 340 and therefore utilization of the administrative access path does not provide access to the registered biometric information relating the consumer information stored in database 330. In one embodiment, the database 330 contains no linking information to the information in the biometric database 325. Accordingly, the administrative access server 340 is not able to access or create a link between the biometric information stored in database 325 and the consumer information stored in database 330.

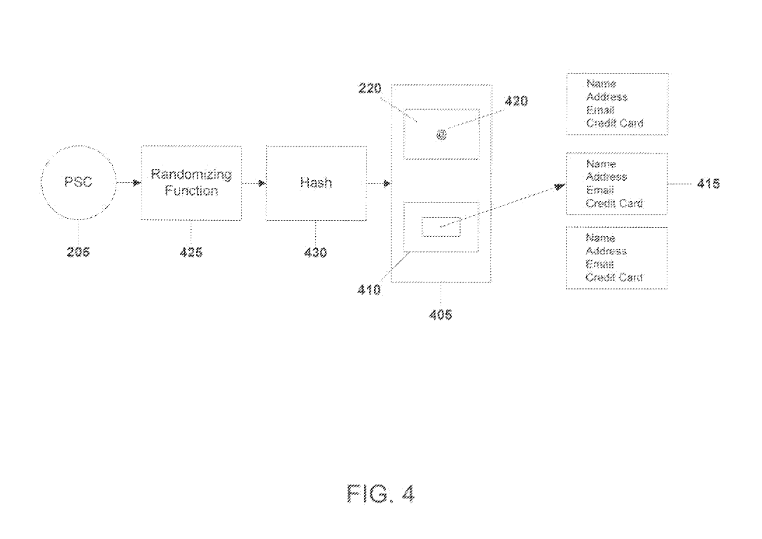

In one embodiment, as depicted in FIG. 4, an individual's biometric information in database 325 is stored in a record 405 (in an appropriate bin number derived from the PSC as taught herein) that also contains a link or address 410 to a record 415 in database 330 that contains the relevant individual's personal information. As depicted in FIG. 4, only the biometric information 420 (e.g., biometric template or image) has been encrypted by the encryption key 220 that is derived from the PSC as further detailed in FIG. 2; however, those with ordinary skill in the art will recognize that the entire record 405, including the link to the individual's record 415 could also be encrypted by the encryption key 220. Note that in the embodiment of FIG. 4, the individual's record 415 does not have a link or address back to the relevant biometric record 405. As such, access to an administrative access server, such as 340 in FIG. 3, which provides access to the individual's record 415 may not provide an easy way to obtain the individual's related biometric information (still in encrypted form due to the encryption key 220) to the individual's record 415. Furthermore, as depicted in FIG. 4, similar to the calculation of the encryption key 220 in FIG. 2, the biometric access system may apply an encryption algorithm (with an encryption key known to the biometric access system) or other one-to-one deterministic function (i.e.,a deterministic function that outputs a unique result for each unique input, unlike deterministic function 225) and a hash function 430 to the PSC 205 or any similar combination of deterministic functions, encryption algorithms, hash functions, etc. known to those with ordinary skill in the art to calculate a link to a unique address to the correct record 415 in the consumer database. In such an embodiment, the PSC 205 may need to be unique in order to assure the generation of a unique address for each individual record. The actual address is thus not stored in a record such as 405 but rather obtained in real time during an access request, when the individual submits his PSC 205. Alternatively, as those with ordinary skill in the art will recognize, a unique stored value “representing” the address or link may be stored in the record 405 and manipulated by a calculation that includes the individual's PSC 205 as an input in order to calculate and produce the true address or link value. In such an alternative embodiment, the PSC 205 may not need to be unique, given the uniqueness of the stored value. As those with ordinary skill in the art will note, any such derivation process (e.g., function plus hashing) should ultimately result in a unique legitimate link or address value (or a value linked to a legitimate address table) in the consumer database 330 for each individual's record. Similarly, depending on the strength of security desired, the deterministic function 425 and hash function 430 or other computational process may or may not be the same or similar to those used in FIG. 2 for the derivation of the encryption key 220 or the bin number 235. However, in such an embodiment, the deterministic function 425 and hash function 430 may aid in generating or maintaining a unique end result of the calculation (in addition to minimize risks of reverse engineering). In such an embodiment as depicted in FIG. 4, any successful derivation of the encryption key by an unauthorized “backer” that did not involve reverse engineering the PSC 205 (e.g., brute force decryption methodologies) may only lead to decrypted biometric information 420 and may not enable such a hacker to access the relevant identity by accessing the individual's record 415 because the address 410 would need to be separately derived from the PSC.

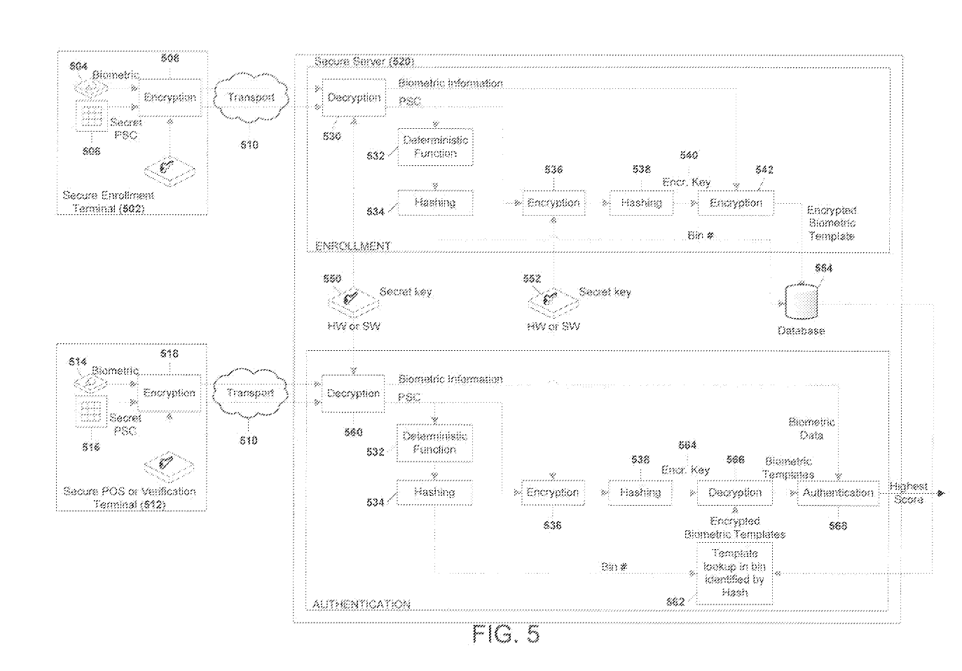

FIG. 5 depicts a block diagram for enrollment and authentication of biometric data in a biometric access system according to an embodiment. When enrolling an individual's account, the individual may supply biometric information 504 (e.g., biometric image which may be converted into a biometric template) and a secret PSC 506 to a secure enrollment terminal 502, for example and without limitation, located at a merchant location, installed as part of a personal computer system to which the individual has access or embodied in a handheld device. The enrollment terminal 502 may encrypt 508 the received information and transmit the information across a transport medium 510 such as the Internet, intranet, private network or other similar network to a secure server 520 managed by the biometric access system. The secure server 520 may enroll the received information by decrypting 530 the information to determine the biometric information 504 and the PSC 506. The incoming information may be decrypted 530 using a first secret key 550 which may be embodied in hardware and/or software. A deterministic function 532 (as further depicted and described in FIG. 2) may be applied to the PSC 506. A first hash function 534 (as further depicted and described in FIG. 2) may be applied to the result of the deterministic function 532. The result of the first hash function 534 may be a bin number corresponding to a bin in which to store the biometric information 504 in the biometric database 325. The PSC 506 may also be encrypted 536 using a second secret key 552 which also may be embodied in hardware and/or software. A second hash function 538 may be applied to the encrypted PSC as a seed value to produce an encryption key 540. The encryption key 540 may be used to encrypt 542 the biometric information 504. The encrypted biometric information may then be stored in a database 554 in a bin corresponding to the bin number and the encryption key 540 is discarded from the biometric access system. While not depicted in FIG. 5., those skilled in the art will recognize that the enrollment process may further request personal information such as name, address, payment modalities, etc. for the individual that may be stored in the consumer database 330.

When authenticating an individual's account (e.g., for the purchase of goods or services, etc.), the individual may similarly supply biometric information 514 and a secret PSC 516 to a secure POS (or other verification terminal) 512 located at a merchant location or any other appropriate location or device as described elsewhere herein. The POS 512 may encrypt 518 the received information (similar to 508 in the enrollment process) and transmit the information across the transport medium 410 to the secure server 420. In one embodiment, the enrollment terminal 502 may be the same as the POS 512 (i.e., if the POS terminal also ha enrollment capabilities). The secure server 420 may authenticate the received information by decrypting 560 the information to determine the biometric information 514 and the secret PSC 516. Similar to step 530, the incoming information may be decrypted 560 using the first secret key 550. The deterministic function 532 may then be applied to the PSC 516 and the first hash function 534 may be applied to the result of the deterministic function 532 resulting in the bin number in which the registered biometric information is expected to be stored. The bin number may then be used to retrieve 562 one or more of the encrypted biometric information (e.g., biometric templates) stored in the bin of the database 554 corresponding to the bin number. The PSC 516 may also be encrypted 536 using the second secret key 552. The second hash function 538 may be applied to the encrypted PSC as a seed value to produce a decryption key 564. In a symmetric encryption system, the encryption key 540 is the same as the decryption key 564. The decryption key 564 may then be used to decrypt 566 the encrypted biometric information from the bin of database 554 corresponding to the bin number. The matching biometric information may be authenticated 568 with the supplied biometric information 514. Those with ordinary skill in the art will recognize that the biometric access system will be able to successfully assess whether particular stored encrypted biometric information in the bin has been successfully decrypted with the decryption key 564 because the format of unencrypted biometric information would be recognizable by the system (i.e., decrypting biometric information with the incorrect key would likely result in non-sensical data or would not successfully complete the decryption process). If more than one biometric template is successfully decrypted (e.g., different individuals have chosen the same PSC, for example), then the matching algorithm that compares the supplied biometric information 514 with the registered biometric information may provide the highest threshold score for the correct registered biometric information when compared to the supplied biometric information 514.

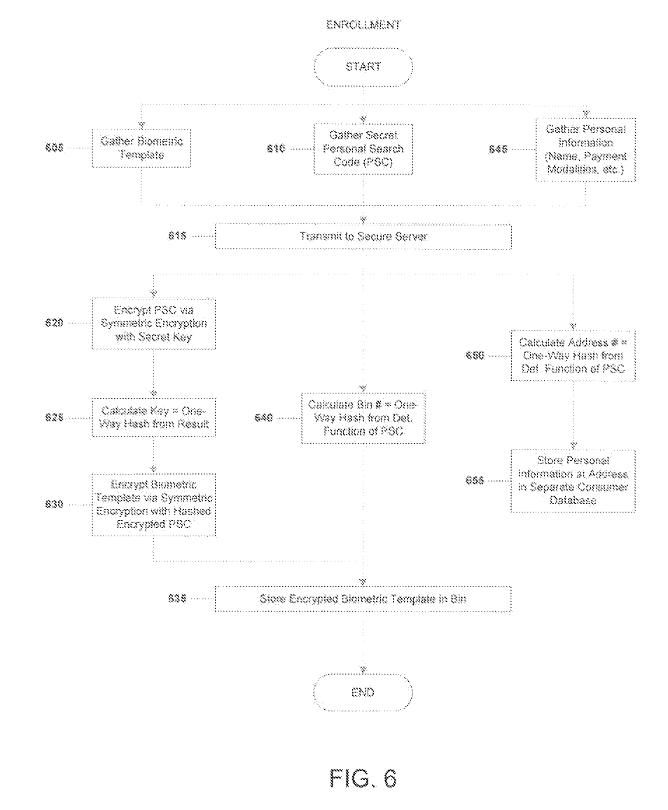

FIG. 6 depicts a flow diagram for an exemplary enrollment process in a biometric access system according to an embodiment. As shown in FIG. 6, enrolling an individual may begin by gathering biometric information such as a biometric template 605 and a secret PSC 610. The biometric template 605 and the PSC 610 may be transmitted 615 to a secure server using a secure channel. The channel may be secured by using a symmetric encryption algorithm, such as Triple DES, AES or the like. Once the biometric template 605 and the PSC 610 are received and decrypted by the secure server, an encryption key may then be calculated. As previously detailed, the PSC 610 may be encrypted using a symmetric encryption algorithm with a secret key know to the secure server 620. A one-way hash may then be applied to the result 625. The result of the one-way hash may serve as an encryption key to encrypt the biometric template in step 630. The encrypted biometric template may be stored 635 in the bin having the appropriate bin number, also determined and dependent upon the PSC 610. In a simultaneous fashion, the bin number may be calculated 640 by applying a one way hash on the result of a deterministic function performed on the PSC 610. In step 635, the encrypted biometric template may then be stored in the appropriately calculated bin number. Those with ordinary skill in the art will recognize that additional enhancements may be added to the process of FIG. 6 to provide additional security during an access attempt by an individual. For example and without limitation, to the extent pre-existing stored templates in a selected bin can be successfully decrypted using the enrollee's PSC, such pre-existing stored templates may be compared against the enrollee's submitted biometric template. To the extent that the enrollee's submitted biometric template is “too similar” to such pre-existing stored templates, the biometric access system may request that the enrollee select a different PSC (and ultimately a different bin) to lessen the risk of a false acceptance during an access request. Additionally, in a further enhanced embodiment, during the enrollment process, personal information including, but not limited to the name of the individual and various payment modalities (e.g., credit card, debit card, checking account, etc.) may also be obtained from the individual 645 and transmitted to the secure server in step 615 (or alternatively, a separate server for maintaining personal information). The secure server may receive the personal information and in similar fashion to the calculation of the bin number, may apply a one-to-one deterministic function to the PSC 610 and may subsequently apply a one-way hash function to the result 650. The result of this one-way hash may serve as a link or address to a separate consumer database wherein the personal information is placed into a record and stored at such address 655.

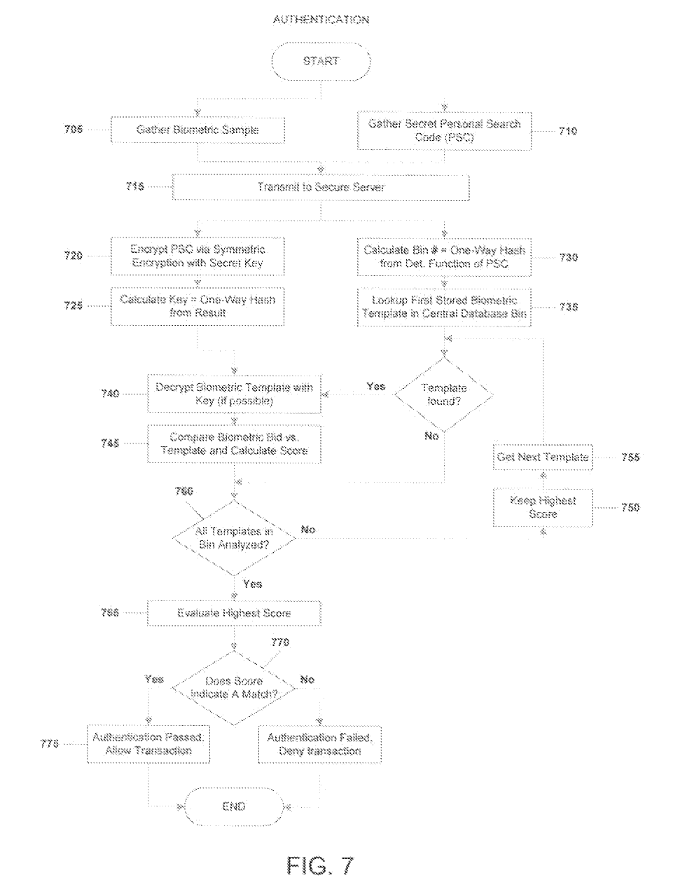

FIG. 7 depicts a flow diagram for an exemplary authentication process in a biometric access system according to an embodiment. Similar to the enrollment process of FIG. 6, as shown in FIG. 7, authenticating an individual may also begin, for example, at a POS terminal at a merchant location, by gathering a biometric sample (e.g., biometric template) 705 and a secret PSC 710 from the individual. The biometric sample 705 and the PSC 710 may be transmitted 715 to the secure server using a secure channel. Once the biometric sample 705 and the secret PSC 710 arrive at the secure server, a decryption key may be derived by encrypting the PSC using a symmetric encryption algorithm with a secret key known to the biometric access system 720 and applying a one-way hash of the encrypted PSC 725. Simultaneously, a bin number may also be derived from the PSC 710 by applying to a one-way hash to the result of a deterministic function that is performed on PSC 730.

Once the bin number is derived, the derived decryption key may be applied to the first stored encrypted registered biometric template in the bin 740. If the decryption is successful (e.g., determined by examining the format of the decrypted result to assess whether it matches the correct format for an unencrypted biometric template, for example), the decrypted registered biometric template may be compared to the received sample biometric template to determine a threshold biometric comparison score according to the biometric template comparison 745. All registered biometric templates in the bin may be analyzed in this manner (see steps 750 and 755) with the possibility that some will successfully decrypt (i.e., individuals used the same PSC) and some will not successfully decrypt (i.e., individuals used different PSCs but such PSCs hashed to the same bin). Once all registered biometric templates have been analyzed 760, a comparison score for those registered templates that successfully decrypted may be determined by comparing such registered templates against the sample biometric template 765. If the highest score meets the threshold set by the biometric access system that indicates a successful authentication 770, the identity of the individual is authenticated 775. Those with ordinary skill in the art will recognize that alternative process flows may be used to achieve the same result as compared to FIG. 7. For example, rather than decrypting and comparing all the templates in a bin and then selecting the highest score to compare against the threshold, an alternative process flow may decrypt and compare only those biometric templates up to the point that a first biometric template with a comparison score that meets the threshold is discovered. Additionally, while not depicted, in further enhanced embodiments, once the individual is authenticated, a one-to-one deterministic function and one-way hash may be applied to the secret PSC in a manner similar to deriving the bin number. Such a process may derive a link or address to the appropriate individual account record at the consumer database where the individuals' personal information is stored (separate from the biometric database). The biometric access system may thereby be able to access the appropriate personal information (e.g., payment modalities such as credit cards, debit cards, checking account, etc.) requested by the individual at the secure POS or verification terminal.

Although the present invention has been described with reference to the alternative embodiments, those of ordinary skill in the art will recognize that changes may be made in form and detail without departing from the spirit and scope of this disclosure. For example and without limitation, in varying embodiments, the PSC may be fixed or be allowed to vary in its length (e.g., the length could be greater than or equal to ten alphanumeric characters). In addition, as suggested in the descriptions herein, the biometric access system may encourage the individual to hold the PSC as a secret. Those with ordinary skill in the art will recognize that the ability to increase the variability in PSCs affects the success of brute force attacks. For example, a variable length PSC (e.g., greater than ten characters) wherein each character may be selected from any alphanumeric character or punctuation character increases the difficulty for brute force methodologies to overcome the system, as compared to a fixed ten digit PSC. Similarly, while the foregoing descriptions have focused on identification systems where binning is used to speed up the searching for the appropriate registered biometric information, those with ordinary skill in the art will recognize that the techniques described herein, particularly as they pertain to using the PSC to encrypt registered biometric information, also apply in verification systems where each individual may utilize a unique PIN such that binning is not needed. Terminology used in the foregoing description is for the purpose of describing the particular versions or embodiments only, and is not intended to limit the scope of the present invention which will be limited only by the appended claims. For example, the term “biometric information” is used throughout the disclosure and is not meant to limit the disclosure to any particular type biometric information, such as a fingerprint, eye scan or voice print or form of biometric information (e.g., biometric template or biometric image). Similarly, reference to a “biometric template” is a reference to one or more biometric templates and equivalents thereof known to those skilled in the art. As used herein and in the appended claims, the singular forms “a,” “an,” and “the” include plural references unless the context clearly dictates otherwise. Similarly, the words “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications, additions and substitutions and the like can be made without departing from the spirit of the invention and these are therefore considered to be within the scope of the invention as defined in the following claims.

What is claimed is:

1. A method for storing biometric information received from an individual in a database, the method comprising:
receiving a personal identification number from the individual;
obtaining biometric information associated with the individual;
applying a calculation on the personal identification number, wherein the result of the calculation serves as an encryption key;
encrypting the biometric information using the encryption key; and
storing the encrypted biometric information in the database.

2. The method of claim 1 wherein the calculation comprises encrypting the personal identification number and applying a one-way hash on the result of the encryption of the personal identification number.

3. The method of claim 1 further comprising:
applying a second calculation on the personal identification number, wherein the result of the second calculation servers as a bin number in the database in which to store the biometric information; and
wherein storing the encrypted biometric information in the database comprises storing the encrypted biometric information in a bin associated with the bin number.

4. The method of claim 3 wherein the second calculation comprises applying a deterministic function on the personal identification number and applying a one-way hash on the result of the deterministic function.

5. The method of claim 1 wherein the personal identification number comprises a secret personal search code.

6. A method for storing personal information received from an individual in a database, the method comprising:
receiving a personal identification number from the individual;
receiving personal information from the individual;
applying a calculation on the personal identification number, wherein the result of the calculation serves as a link to a unique address in the database for storing personal information; and
storing the received personal information at the unique address.

7. The method of claim 6 wherein the calculation comprises applying a deterministic function on the personal identification number and applying a one-way hash on the result of the deterministic function.

8. The method of claim 6 wherein the personal identification number is unique.

9. The method of claim 6 wherein the result of the calculation is unique.

10. The method of claim 6 wherein a unique stored value relating to the individual is used as an input to the calculation.

11. The method of claim 10 further comprising:
receiving biometric information associated with the individual;
storing the biometric information and the unique stored value in a record, wherein successful authentication of sample biometric information during an access request provides access to the unique stored value.

12. A method for accessing an individual's stored personal information in a biometric access system, the method comprising:
receiving a personal identification number from an individual;
obtaining sample biometric information associated with the individual;
applying a calculation on the personal identification number, wherein a result of the calculation serves as a decryption key;
decrypting encrypted registered biometric information stored in a database of the biometric access system with the result of the calculation;
upon successful decryption of such encrypted registered biometric information, comparing the sample biometric information with the decrypted registered biometric information to determine a match; and
upon successful determination of a match, accessing stored personal information relating to the individual in the biometric access system.

13. The method of claim 12 wherein the calculation comprises encrypting the personal identification number and applying a one-way hash on the result of the encryption of the personal identification number.

14. The method of claim 12 further comprising:
applying a second calculation on the personal identification number, wherein the result of the second calculation serves as a bin number in the database in which to access registered biometric information; and
wherein decrypting encrypted registered biometric information stored in the database comprises decrypting at least one encrypted registered biometric information stored in the bin number represented by the result of the second calculation.

15. The method of claim 14 further comprising:
applying a third calculation on the personal identification number, wherein the result of the third calculations serves as a link to a unique address wherein a record of the individual's personal information is stored; and
wherein accessing stored personal information relating to the individual in the biometric access system comprises accessing the record stored at the unique address represented by the result of the third calculation.

16. The method of claim 15 wherein the third calculation comprises applying a deterministic function on the personal identification number and applying a one-way hash on the result of the deterministic function.

17. The method of claim 15 wherein a unique stored value relating to the individual is used as an input to the third calculation.

18. The method of claim 15 wherein the result of the third calculation is unique.

19. The method of claim 14 wherein the second calculation comprises applying a deterministic function on the personal identification number and applying a one-way hash on the result of the deterministic function.

20. The method of claim 12 wherein the personal identification number is unique.

21. A system form securely storing biometric information and personal information relating to and individual, the system comprising:
a biometric database, wherein registered biometric information of the individual is stored, wherein the stored registered biometric information is encrypted using the result of a calculation on a personal identification number known only to the individual; and
a personal information database segregated from the biometric database, wherein the personal information database contains one or more records, wherein personal information relating to the individual is stored in a record.

22. The system of 21 wherein the individual's registered biometric information is stored in a bin in the biometric database, wherein the bin number associated with the bin is derived from a second calculation of the personal identification number.

23. The method of claim 22 wherein the second calculation comprises a deterministic function and a one-way hash function applied to the personal identification number.

24. The system of claim 21 wherein the address of the record in the personal information database is obtained by applying a second calculation to the personal identification number.

25. The method of claim 24 wherein the second calculation comprises a deterministic function and a one-way hash function applied to the personal identification number.

26. The method of claim 24 wherein a unique stored value relating to the individual is used as an input to the third calculation.

27. The system of 21 wherein the calculation comprises an encryption algorithm and a one-way hash function applied to the personal identification number.

28. The method of claim 27 wherein the result of the calculation is unique.
